(19) United States
(12) Patent Application Publication
(10) Pub. No.: US 2015/0239144 A1
(43) Pub. Date: Aug. 27, 2015

(54) LUMBER EDGER HAVING ACCESSIBLE SAWS AND METHOD OF ACCESSING LUMBER EDGER SAWS

(71) Applicant: Baxley Equipment Co., Hot Springs, AR (US)

(72) Inventors: Russell R. Kennedy, Hot Springs, AR (US); David Adam Carty, Hot Springs, AR (US)

(73) Assignee: Baxley Equipment Co., Hot Springs, AR (US)

(21) Appl. No.: 14/188,729

(22) Filed: Feb. 25, 2014

(51) Int. Cl. B27B 31/06; B27G 19/02; B27B 5/30

(52) U.S. Cl. CPC B27B 31/06; B27B 5/30; B27G 19/02

(57) ABSTRACT

A lumber edger a first edger saw constructed to edge the lumber, a second edger saw constructed to edge the lumber. The first and second edger saws oppose one another when the first and second edger saws are in a cutting position. A movable mount is connected to the first edger saw and/or second edger saw. The movable mount has a first mount position in which the first and second edger saws are in a cutting position and at a first distance from each other and a second mount position in which the first and second edger saws are in a non-cutting position and at a second distance from each other. The second distance is greater than the first distance. Also provided is a method of using accessing the first and second edger saws.

### FIELD OF THE INVENTION

The invention relates to a lumber edger having accessible saws and a method accessing the saws of the lumber edger.

### BACKGROUND OF THE INVENTION

Lumber edgers saw off the rough side edges of freshly sawn lumber (planks), called flitches, to produce 4 sided boards using edger saws. The edger saws are parallel to each other and typically about 4″, 6″, 8″, 10″ or 12″ apart.

Many of these edgers are of the “independent arbor” type, meaning there is an independently driven arbor on each side of the centerline chain. These arbors can contain one or more saws each. The saws are typically collared saws or guided saws. Each arbor is moved in or out via a setworks cylinder, normally hydraulically positioned with a temposonics feedback and servo valve to set the position desired.

Aside from the many advantages an independent arbor edger can offer, one of the major drawbacks over the years has been accessibility of saws to replace or service them. This type of edger normally would have a lid or door on the top that would open via air or hydraulic cylinder. The operator would then have to lean down into or climb down into edger box to change the saws. The collars are heavy and hard to lift out of the box. Furthermore, the saws are dirty and sharp.

A lumber edger is described in my previous published U.S. patent application No. 2013/0269836, filed 11 Apr. 2013, which is incorporated herein by reference. Further examples of lumber edgers are disclosed in U.S. Pat. Nos. 6,308,756; 4,803,371; 4,676,130; and 4,462,443, the complete disclosures of which are incorporated herein by reference.

### SUMMARY OF THE INVENTION

An objective of the invention is to provide an improved lumber edger in which the saws can be more easily and safely changed.

The invention modifies now well-known edgers to provide a linear way under one or both sides of the independent arbor module assemblies. In order to change the saws, the operator can now unlock a module assembly and slide the module assembly away from the other module assembly. A portion of the edger wall that is attached to the module and can move back with module assembly, allowing room for the operator to enter the edger to easily and safely change the saws. There can still be a top door that can be raised to provide additional headroom. A platform can be lowered for the operator to work on.

These objectives and other objectives can be obtained by a lumber edger comprising:
a first edger saw constructed to edge the lumber;
a second edger saw constructed to edge the lumber, wherein the first and second edger saws oppose one another when the first and second edger saws are in a cutting position; and
a movable mount connected to the first edger saw and/or second edger saw, the movable mount having a first mount position in which the first and second edger saws are in a cutting position and at a first distance from each other and a second mount position in which the first and second edger saws are in a non-cutting position and at a second distance from each other, the second distance being greater than the first distance.

These objectives and other objectives can be obtained by a method of changing a saw on a lumber edger comprising a first edger saw constructed to edge the lumber, a second edger saw constructed to edge the lumber, wherein the first and second edger saws oppose one another when the first and second edger saws are in a cutting position, and a movable mount connected to the first edger saw and/or second edger saw, the movable mount having a first mount position in which the first and second edger saws are in a cutting position and at a first distance from each other and a second mount position in which the first and second edger saws are in a non-cutting position and at a second distance from each other, the second distance being greater than the first distance, the method comprising:
moving the first and second edger saws away from one another and into the non-cutting position using the movable mount;
performing maintenance on the first edger saw and/or the second edger saw; and
moving the first and second edger saws back into the cutting position.

### BRIEF DESCRIPTION OF THE DRAWINGS

FIG. 1A illustrates an elevated view of the lumber edger with the saws in a cutting position.

FIG. 1B illustrates an elevated view of the lumber edger with the saws separated in a non-cutting position.

FIG. 2 illustrates a side view of the lumber edger.

FIG. 3 illustrates a front view of the lumber edger with the saws in a cutting position.

FIG. 4 illustrates a front view of the lumber edger with the saws separated from one another in a non-cutting position.

### DETAILED DESCRIPTION OF THE INVENTION

The invention will be explained with reference to the attached non-limiting drawings.

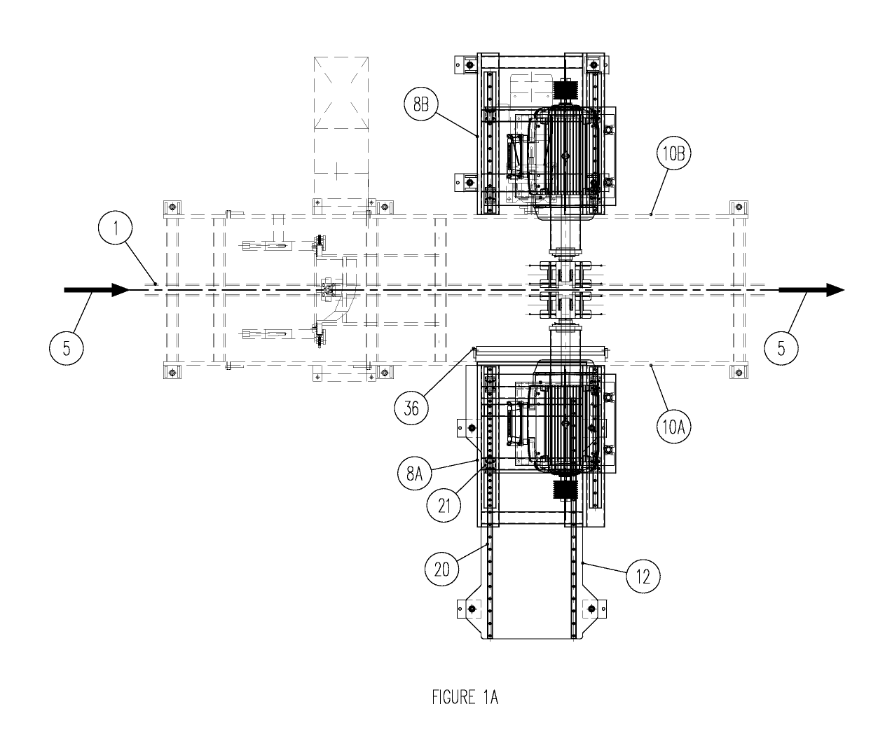

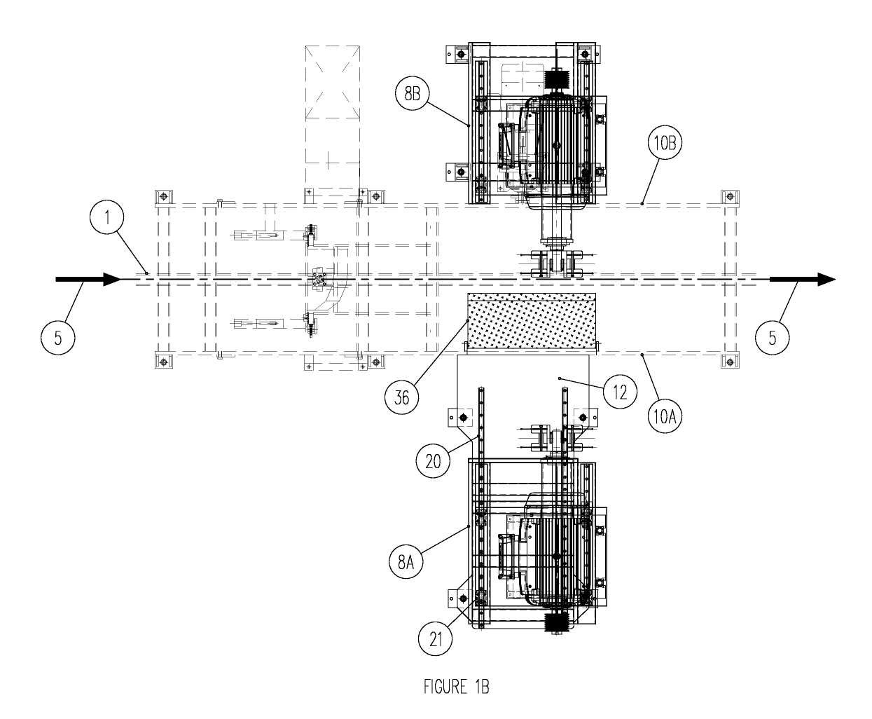

FIGS. 1A and 1B show a top view of an exemplary edger system having a conveyor 1 for conveying the lumber (flitch) which comprises of a plurality of lugged chains. The system usually includes a scanner for scanning dimensions of the lumber, which can comprise laser range finders that measure the differential thickness of the board as it passes through. However, the scanner is not required. The scanner is connected to a computer system, which calculates theoretical edge positions. The system additionally includes a positioning system constructed to position the lumber in relation to the first edger saw 6A and the second edger saw 6B. The lumber flows in direction 5 on the conveyor 1. In FIG. 1A the edger saws 6A and 6B are in a cutting position. In FIG. 1B the edger saws 6A and 6B are separated from one another in a non-cutting position.

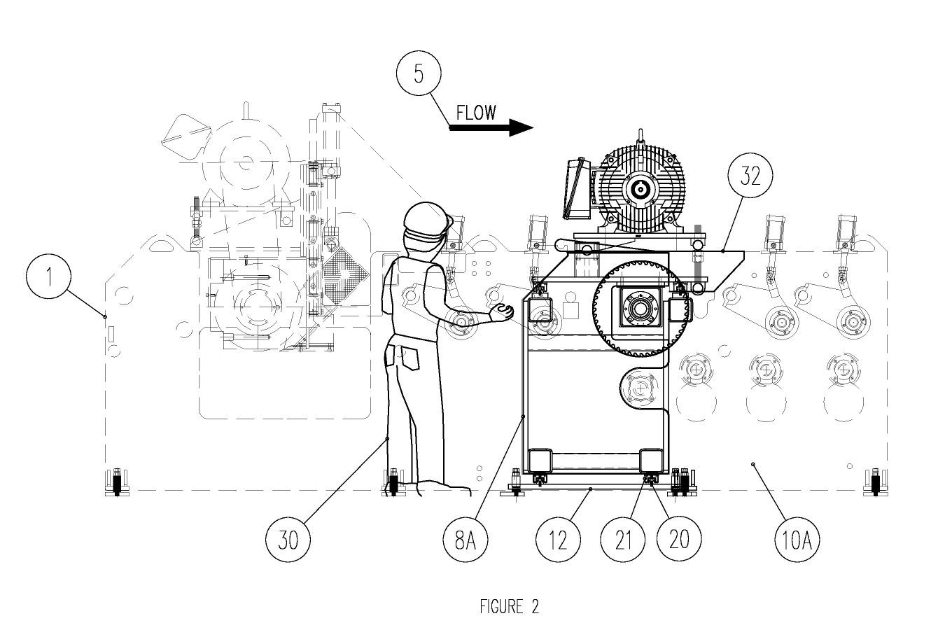

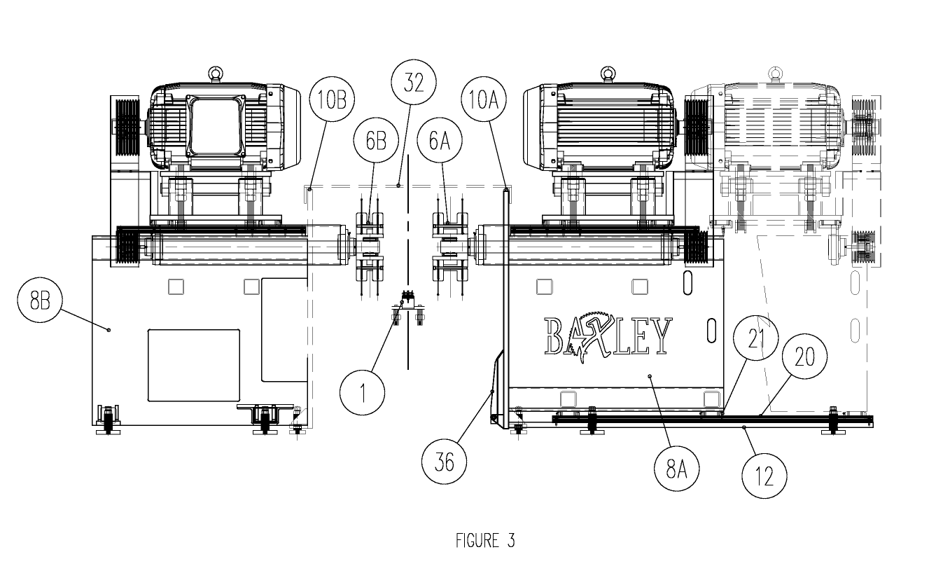

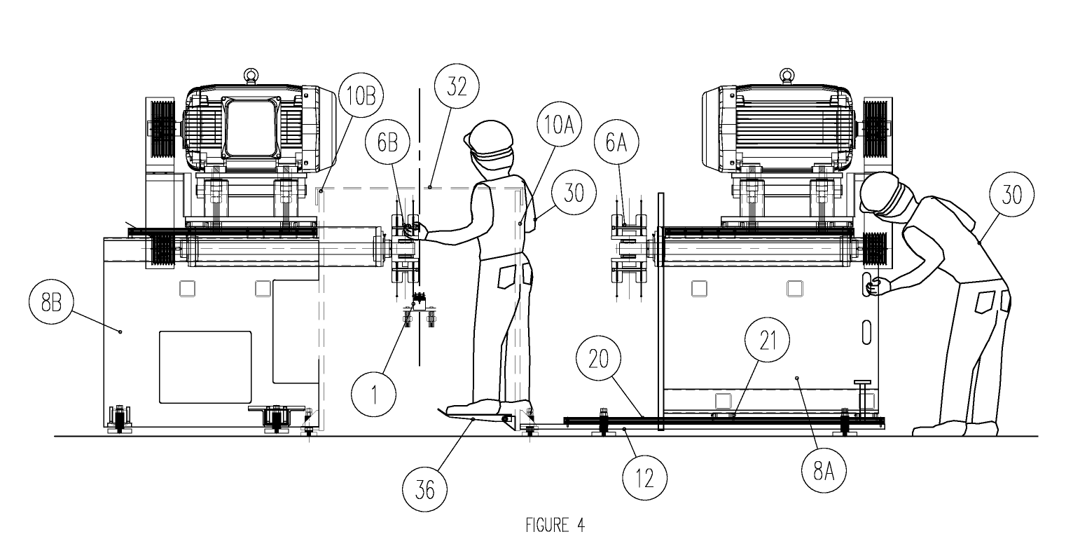

FIG. 2 shows a side view of the lumber edger. FIG. 3 illustrates a front view of the lumber edger with the edger saws 6A and 6B in a cutting position. FIG. 4 illustrates a front view of the lumber edger with the edger saws 6A and 6B separated from one another in a non-cutting position.

The saws 6A and 6B are mounted in associated module assemblies 8A and 8B. The saws 6A and 6B are usually mounted on slides in the module assemblies 8A and 8B, so that the saws 6A and 6B can be slide back-and-forth during use of the edger. The module assemblies 8A and 8B, in addition to the associated edger saws 6A and 6B, have associated motors to drive the saws 6A and 6B. At least one of the module assemblies 8A and 8B is mounted on a movable mount 12. The modules 8A and 8B can also have associated edger walls 10A and 10B. The modules 8A and 8B preferably can move independently of one another.

The movable mount 12 has a first mount position in which the first and second edger saws 6A and 6B are in a cutting position and at a first distance from each other as shown in FIGS. 1A and 3. The movable mount 12 has a second mount position in which the first and second edger saws 6A and 6B are in a non-cutting position and at a second distance from each other, the second distance being greater than the first distance, as shown in FIGS. 1B, 2 and 4. When the first and second saws 6A and 6B are in the non-cutting position, an operator 30 can easily provide maintenance on the first and second saws 6A and 6B, as shown in FIGS. 2 and 4.

The movable mount 12 can comprise, for example, rails 20 and wheels 21. Any suitable movable mount 12 can be utilized as desired, including but not limited to slides, wheels, or bearings.

To facilitate servicing of the edger saws 6A and 6B, a platform 36 having a movable mount, which has a first platform position shown in FIGS. 1A and 3 that allows the edger saws 6A and 6B to be in a cutting position and a second platform position shown in FIGS. 1B, 2 and 4 that allows an operator 30 to stand on between the edger saws 6A and 6B when the first and second saws are in the non-cutting position can be used.

Typically, the edger has a moveable hatch door 32 that can be opened to access and service the edger saws 6A and 6B. Conventional edger systems can now be modified as described herein to provide safer and easier servicing of the edger saws 6A and 6B.

The invention also relates to a method of providing maintenance on the edger saws 6A and 6B. The method comprises the steps of moving the first and second saws 6A and 6B away from one another and into the non-cutting position using the movable mount 12, shown in FIGS. 1B, 2 and 4. The operator 30 then performs maintenance on at least one of the first and second edger saws 6A and 6B. Once the maintenance is completed, the first and second edger saws 6A and 6B are moved back into the cutting position as shown in FIGS. 1A and 3.

The method can also comprise moving the platform 36 into the second position when the first and second saws 6A and 6B are in the non-cutting position, as shown in FIGS. 1B, 2 and 4, and moving the platform 36 into the first position shown in FIGS. 1 and 3 to allow the first and second saws 6A and 6B to move into the cutting position.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appended claims.

We claim:

1. A lumber edger comprising:
a first edger saw constructed to edge the lumber;
a second edger saw constructed to edge the lumber, wherein the first and second edger saws oppose one another when the first and second edger saws are in a cutting position; and
a movable mount connected to the first edger saw and/or second edger saw, the movable mount having a first mount position in which the first and second edger saws are in a cutting position and at a first distance from each other and a second mount position in which the first and second edger saws are in a non-cutting position and at a second distance from each other, the second distance being greater than the first distance.

2. The lumber edger according to claim 1, wherein the second distance is sufficient to allow a human between the first and second edger saws.

3. The lumber edger according to claim 1, further comprising a movable platform having a first platform position that allows the first and second saws to be in a cutting position and a second platform position that allows a human to stand on between the first and second saws when the first and second saws are in the non-cutting position.

4. The lumber edger according to claim 1, further comprising a movable hatch located above the first and second saws, the hatch being constructed to allow access to the first and second saws.

5. The lumber edger according to claim 1, wherein the movable mount is connected to both the first and second saws.

6. A method of changing a saw on a lumber edger comprising a first edger saw constructed to edge the lumber, a second edger saw constructed to edge the lumber, wherein the first and second edger saws oppose one another when the first and second edger saws are in a cutting position, and a movable mount connected to the first edger saw and/or second edger saw, the movable mount having a first mount position in which the first and second edger saws are in a cutting position and at a first distance from each other and a second mount position in which the first and second edger saws are in a non-cutting position and at a second distance from each other, the second distance being greater than the first distance, the method comprising:
moving the first and second edger saws away from one another and into the non-cutting position using the movable mount;
performing maintenance on the first edger saw and/or the second edger saw; and
moving the first and second edger saws back into the cutting position.

7. The method according to claim 6, wherein the lumber edger further comprising a movable platform having a first platform position that allows the first and second saws to be in a cutting position and a second platform position that allows a human to stand on between the first and second saws when the first and second saws are in the non-cutting position, the method further comprising moving the platform into the second position when the first and second saws are in the non-cutting position and moving the platform into the first position to allow the first and second saws to move into the cutting position.
